(19) United States
(12) Patent Application Publication
(10) Pub. No.: US 2018/0027138 A1
(43) Pub. Date: Jan. 25, 2018

(54) IMAGE FORMING APPARATUS, CONTROL PROGRAM, AND CONTROL METHOD

(71) Applicant: Sharp Kabushiki Kaisha, Sakai City (JP)

(72) Inventor: Takahiro KAWAKAMI, Sakai City (JP)

(21) Appl. No.: 15/644,912

(22) Filed: Jul. 10, 2017

(30) Foreign Application Priority Data
Jul. 19, 2016 (JP) 2016-141643

(51) Int. Cl. H04N 1/00

(52) U.S. Cl. CPC H04N 1/00896; H04N 1/00925; H04N 1/00411; H04N 1/00424; H04N 2201/0094

(57) ABSTRACT

An image forming apparatus has the power saving mode and the normal mode in which power consumption is not restricted. The image forming apparatus includes a CPU and a display with a touch panel. Under instructions from the CPU, a power saving inhibition icon for inhibiting switching from the normal mode to the power saving mode is displayed on the display with the touch panel. The power saving inhibition icon is touched so that switching to the power saving mode is inhibited. After that, when it is determined that a job that has been first performed after the inhibition has been completed, the inhibition of switching to the power saving mode is canceled.

### BACKGROUND

### 1. Field

The present disclosure relates to an image forming apparatus, a control program, and a control method. In particular, for example, the present disclosure relates to an image forming apparatus, a control program, and a control method in which the power saving state in which power consumption is restricted and the normal state in which power consumption is not restricted are provided.

### 2. Description of the Related Art

Japanese Unexamined Patent Application Publication No. 2003-015479 discloses an exemplary image forming apparatus of the related art. The image forming apparatus disclosed in Japanese Unexamined Patent Application Publication No. 2003-015479 has a function of making a transition to the power saving mode, and is provided with a power-saving-mode transition inhibition key. When the power-saving-mode transition inhibition key is operated, the image forming apparatus of the related art inhibits transition to the power saving mode. The image forming apparatus is provided with an automatic document feeder and a sheet sensor that detects sheets of paper on a paper output unit of the automatic document feeder. In the image forming apparatus, in the state in which transition to the power saving mode is inhibited, when the sheet sensor detects a change from a state in which sheets of paper are present on the paper output unit of the automatic document feeder to a state in which no sheets of paper are present, the inhibition of transition to the power saving mode is canceled.

In the image forming apparatus of the related art, when a state in which sheets of paper are present on the paper output unit of the automatic document feeder is changed to a state in which no sheets of paper are present, inhibition of transition to the power saving mode is canceled. However, in the image forming apparatus of the related art, when a user forgets taking sheets of paper from the paper output unit, the state in which sheets of paper are present on the paper output unit is maintained. Therefore, inhibition of transition to the power saving mode is not canceled. In addition, when a document is simply to be scanned by using an image reading apparatus, no sheets of paper are conveyed to the paper output unit. Therefore, no sheets of paper will be present on the paper output unit, and inhibition of transition to the power saving mode is not canceled.

Thus, in the image forming apparatus of the related art, inhibition of transition to the power saving mode may not be canceled. If inhibition of transition to the power saving mode is not canceled, a problem of wasted power consumption arises.

Accordingly, the image forming apparatus of the related art has difficulty in achieving efficient power saving, and needs some improvement.

### SUMMARY

Therefore, it is desirable to provide an image forming apparatus, a control program, and a control method that have a novel function.

It is also desirable to provide an image forming apparatus, a control program, and a control method that achieve efficient power saving.

According to an aspect of the disclosure, there is provided an image forming apparatus having a power saving state and a normal state. The power saving state is a state in which power consumption is restricted to a given value or less. The normal state is a state in which power consumption is not restricted. The image forming apparatus includes a switching unit, a determination unit, an inhibition unit, and a canceling unit. The switching unit switches the image forming apparatus between the normal state and the power saving state when a given condition is satisfied. The determination unit determines whether or not an instruction to inhibit the switching performed by the switching unit is given, when the image forming apparatus is in the normal state. The inhibition unit temporarily inhibits the switching performed by the switching unit, when the determination unit determines that the instruction to inhibit the switching is given. The canceling unit cancels the inhibition of the switching when a job performed in the image forming apparatus is completed. The inhibition is performed by the inhibition unit.

According to an aspect of the disclosure, there is provided an image forming apparatus having a power saving state and a normal state. The power saving state is a state in which power consumption is restricted to a given value or less. The normal state is a state in which power consumption is not restricted. The image forming apparatus includes a switching unit, a determination unit, an inhibition unit, and a canceling unit. The switching unit switches the image forming apparatus between the normal state and the power saving state when a given condition is satisfied. The determination unit determines whether or not an instruction to inhibit the switching performed by the switching unit is given, when the image forming apparatus is in the normal state. When the determination unit determines that the instruction to inhibit the switching is given, the inhibition unit inhibits the switching until a given time is elapsed. The switching is performed by the switching unit. The canceling unit cancels the inhibition of the switching when the given time is elapsed. The inhibition is performed by the inhibition unit.

According to an aspect of the disclosure, there is provided a control program for an image forming apparatus having a power saving state and a normal state. The power saving state is a state in which power consumption is restricted to a given value or less. The normal state is a state in which power consumption is not restricted. The control program causes a computer in the image forming apparatus to execute a process including switching the image forming apparatus between the normal state and the power saving state when a given condition is satisfied; determining whether or not an instruction to inhibit the switching is given, when the image forming apparatus is in the normal state; inhibiting the switching temporarily when the determining determines that the instruction to inhibit the switching is given; and canceling the inhibition of the switching when a job performed in the image forming apparatus is completed.

According to an aspect of the disclosure, there is provided a control program for an image forming apparatus having a power saving state and a normal state. The power saving state is a state in which power consumption is restricted to a given value or less. The normal state is a state in which power consumption is not restricted. The control program causes a computer in the image forming apparatus to execute a process including switching the image forming apparatus between the normal state and the power saving state when a given condition is satisfied; determining whether or not an instruction to inhibit the switching is given, when the image forming apparatus is in the normal state; inhibiting the switching until a given time is elapsed, the inhibiting being performed when the determining determines that the instruction to inhibit the switching is given; and canceling the inhibition of the switching when the given time is elapsed.

According to an aspect of the disclosure, there is provided a control method for an image forming apparatus having a power saving state and a normal state. The power saving state is a state in which power consumption is restricted to a given value or less. The normal state is a state in which power consumption is not restricted. The control method includes switching the image forming apparatus between the normal state and the power saving state when a given condition is satisfied; determining whether or not an instruction to inhibit the switching is given, when the image forming apparatus is in the normal state; inhibiting the switching temporarily when the determining determines that the instruction to inhibit the switching is given; and canceling the inhibition of the switching when a job performed in the image forming apparatus is completed.

According to an aspect of the disclosure, there is provided a control method for an image forming apparatus having a power saving state and a normal state. The power saving state is a state in which power consumption is restricted to a given value or less. The normal state is a state in which power consumption is not restricted. The control method includes switching the image forming apparatus between the normal state and the power saving state when a given condition is satisfied; determining whether or not an instruction to inhibit the switching is given, when the image forming apparatus is in the normal state; inhibiting the switching until a given time is elapsed, the inhibiting being performed when the determining determines that the instruction to inhibit the switching is given; and canceling the inhibition of the switching when the given time is elapsed.

### BRIEF DESCRIPTION OF THE DRAWINGS

FIG. 1 is a perspective view of the appearance of an image forming apparatus according to an embodiment of the disclosure;

FIG. 2 is a block diagram illustrating the electrical configuration of the image forming apparatus illustrated in FIG. 1;

FIG. 3 is a diagram illustrating an exemplary home screen;

FIG. 4 is a diagram illustrating an exemplary memory map of a random-access memory (RAM) illustrated in FIG. 2;

FIG. 5 is a flowchart of an exemplary power supply control process performed in the image forming apparatus illustrated in FIG. 1;

FIG. 6 is a diagram illustrating an exemplary selection screen according to a third embodiment; and

FIG. 7 is a flowchart illustrating an exemplary power supply control process according to the third embodiment.

### DESCRIPTION OF THE EMBODIMENTS

### First Embodiment

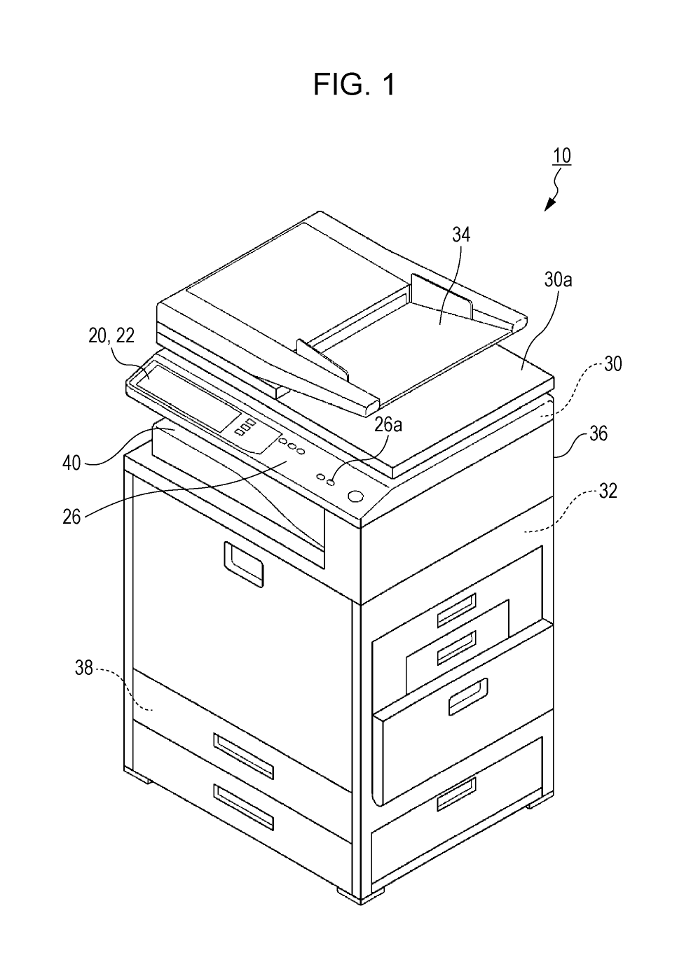

FIG. 1 is a perspective view of the external configuration obtained by viewing an image forming apparatus 10 according to an embodiment of the disclosure from obliquely above.

Referring to FIG. 1, in the first embodiment, the image forming apparatus 10 is a multifunction peripheral (MFP) having a copying function, a printer function, a scanner function, a facsimile function, and the like. The disclosure may be applied not only to a multifunction peripheral but also to other image forming apparatuses, such as a copier (copy machine), a print apparatus (printer), and a facsimile.

The image forming apparatus 10 has an apparatus body 36. The apparatus body 36 includes an image reading unit 30, an image forming unit 32, a manual feeding unit 34, and a sheet feeder 38.

The image reading unit 30 includes platen glass formed by using a transparent material, and is included in the apparatus body 36. Above the platen glass, an openable document cover 30a is attached through hinges and the like. The document cover 30a is provided with the manual feeding unit 34. The document cover 30a is also provided with an automatic document feeder (ADF) that automatically feeds a document that is put on the manual feeding unit 34.

The image reading unit 30 includes a light source, multiple mirrors, an imaging lens, and a line sensor. The image reading unit 30 exposes a document surface to light by using the light source, and guides the reflected light obtained through reflection from the document surface, by using the mirrors to the imaging lens. Then, the imaging lens is used to image the reflected light onto the photo detector of the line sensor. In the line sensor, the brightness or the chromaticity of the reflected light imaged onto the photo detector is detected, and read image data is generated on the basis of an image of the document surface. As a line sensor, a charge coupled device (CCD), a contact image sensor (CIS), or the like is used.

The image forming unit 32 is included in the apparatus body 36, and is disposed below the image reading unit 30. The image forming unit 32 includes exposure units, developers, process units, an intermediate transfer belt unit, a transfer roller, and a fixing unit. The image forming unit 32 forms an image on a recording medium (a sheet of paper) conveyed from the sheet feeder 38 or the like disposed below the image forming unit 32, and ejects the sheet on which an image has been formed, to a paper output tray 40. As image data used in image formation, image data that is read from a document by the image reading unit 30, image data that is received from the outside, or the like is used.

The forming image data used in the image forming apparatus 10 corresponds to four color images of black (K), cyan (C), magenta (M), and yellow (Y). Therefore, for each of a developer, a photoreceptor drum, a cleaner unit, and a charger, four components are provided so as to form four types of latent images corresponding to the colors. Thus, four image stations are formed.

Each of the photoreceptor drums is an image bearing member in which a photoreceptive layer is formed on the surface of cylindrical base having conductivity. Each of the chargers is a member for charging the surface of a corresponding one of the photoreceptor drums at a given potential (for example, −600 V). Each of the exposure units is formed as a laser scanning unit (LSU) including a laser emitting unit and a reflecting mirror. The exposure unit exposes the charged surface of a corresponding one of the photoreceptor drums to light. Thus, an electrostatic latent image according to the forming image data is formed on the surface of a photoreceptor drum. Each of the developers makes an electrostatic latent image formed on the surface of a corresponding one of the photoreceptor drums visible by using toner of a corresponding one of the four colors (YMCK). Each of the cleaner units removes toner remaining on the surface of a corresponding one of the photoreceptor drums by using a cleaning blade after development and image transfer, and conveys the removed toner to a waste-toner box (not illustrated).

The intermediate transfer belt unit includes an intermediate transfer belt, a driving roller, a driven roller, and four intermediate transfer rollers, and is disposed above the photoreceptor drums. The intermediate transfer belt is disposed so as to be in contact with the photoreceptor drums. The intermediate transfer rollers are used to sequentially transfer the color toner images formed on the photoreceptor drums onto the intermediate transfer belt on top of one another. Thus, a multiple-color toner image is formed on the intermediate transfer belt. Near the driving roller, the transfer roller is disposed. A sheet of paper passes through a nip region between the intermediate transfer belt and the transfer roller. Thus, the toner image formed on the intermediate transfer belt is transferred onto the sheet of paper.

The fixing unit includes a heating roller and a pressure roller, and is disposed above the transfer roller. The heating roller is set so as to be heated at a given fixing temperature. The sheet of paper passes through a nip region between the heating roller and the pressure roller. Thus, the toner image that has been transferred onto the sheet of paper is fused, mixed, and pressed so that the toner image is subjected to thermal fixing onto the sheet of paper.

On the front surface of the image reading unit 30, an operation panel 26 is provided. The operation panel 26 includes a display (display unit) 22 with a touch panel 20, and also includes multiple operation buttons 26a.

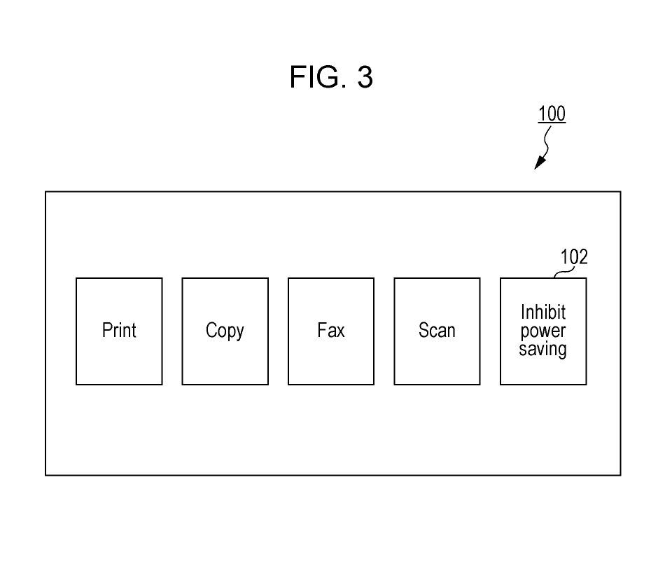

On the display 22 with the touch panel 20, software keys, messages, and the like for receiving various settings, a print instruction, or the like from a user are displayed. For example, on the display 22, a home screen 100 (see FIG. 3) that is a screen for selecting a desired job from various jobs that may be performed by the image forming apparatus 10 is displayed. However, in the first embodiment, the jobs mean copying (including scanning of a document), printing, fax transmission, and the like.

The operation buttons 26a are hardware keys, and include, for example, a home key, a power-saving key, and a main power supply key. The home key is a key for displaying the home screen 100. The power-saving key is a key for switching between the power saving state (power saving mode) in which power consumption is restricted and the normal state (normal mode) in which power consumption is not restricted. When the power-saving key is selected, switching to the power saving mode is performed in the normal mode, and switching to the normal mode is performed in the power saving mode. The main power supply key is a key for turning on/off the main power supply of the image forming apparatus 10.

For example, a software key is referred to as a key reproduced by using software on the display surface of the display 22 with the touch panel 20. In contrast, a hardware key is referred to as a key (button) provided as a physical device.

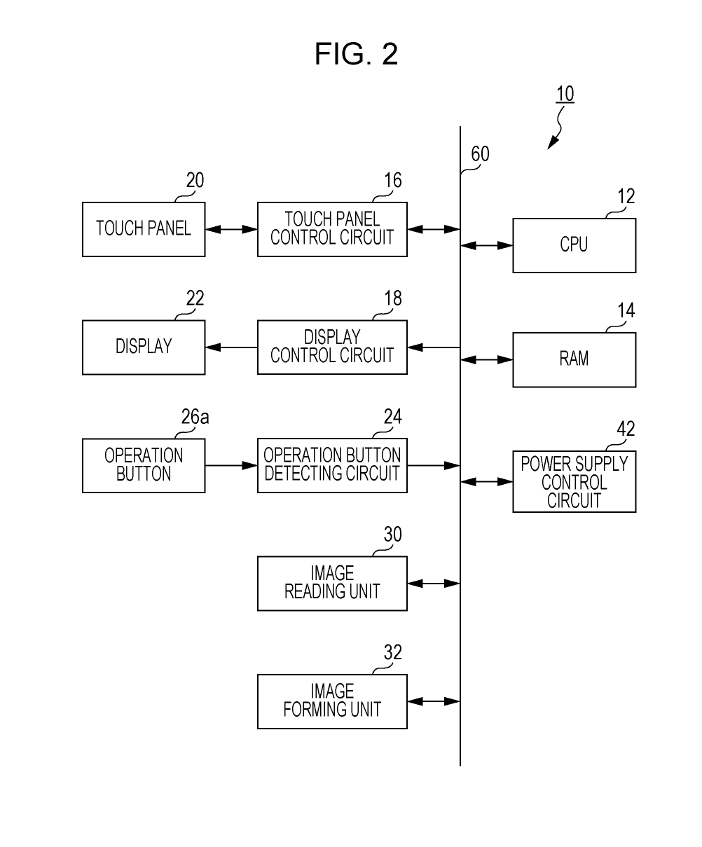

FIG. 2 is a block diagram illustrating the electrical configuration of the image forming apparatus 10 illustrated in FIG. 1. Referring to FIG. 2, the image forming apparatus 10 includes a central processing unit (CPU) 12. A random-access memory (RAM) 14, a touch panel control circuit 16, a display control circuit 18, an operation button detecting circuit 24, an image reading unit 30, an image forming unit 32, and a power supply control circuit 42 are coupled to the CPU 12 through a bus 60. The touch panel 20 is coupled to the touch panel control circuit 16. The display 22 is coupled to the display control circuit 18. The operation buttons 26a are coupled to the operation button detecting circuit 24.

The CPU 12 has overall control over the image forming apparatus 10. The RAM 14 is used as a work area and a buffer area of the CPU 12.

The touch panel control circuit 16 provides a voltage and the like used by the touch panel 20, detects a touch operation (touch input) in an area in which a touch is valid on the touch panel 20, and outputs, to the CPU 12, touch coordinates data indicating the position of the touch input.

The touch panel 20 is a general-purpose touch panel. As the touch panel 20, any type, such as a capacitive sensing type, an electromagnetic induction type, a resistive type, or an infrared ray type, may be used. In the first embodiment, a touch panel of capacitive sensing type is used as the touch panel 20, and the touch panel 20 is disposed on the display surface of the display 22. Alternatively, a touch panel display in which the touch panel 20 and the display 22 are formed as an integral unit may be used.

The display control circuit 18 includes a graphics processing unit (GPU) and a video RAM (VRAM). Under instructions from the CPU 12, the GPU uses image generation data stored in the RAM 14 so as to generate, on the VRAM, display image data for displaying various screens on the display 22, and outputs the generated display image data to the display 22. For example, a liquid crystal display (LCD) or an electro-luminescence (EL) display may be used as the display 22.

The operation button detecting circuit 24 outputs, to the CPU 12, an operation signal or operation data according to operations on the above-described operation buttons 26a.

The power supply control circuit 42 is a control circuit for supplying power supply (power) to the components in the image forming apparatus 10 in accordance with instructions from the CPU 12. The power supply control circuit 42 decreases the voltage of commercial power supply and rectifies the commercial power supply, and supplies a given direct current voltage determined in accordance with the components and stops the supply.

The CPU 12 controls at least an operation state of the image forming apparatus 10. In the first embodiment, the image forming apparatus 10 has an operation state of the power saving mode and the normal mode as described above. For example, in the normal mode, the CPU 12 controls the power supply control circuit 42 so that power supply is supplied to all of the components of the image forming apparatus 10. The normal mode is set when the main power supply of the image forming apparatus 10 is turned on and when switching from the power saving mode to the normal mode is performed.

In the power saving mode, the CPU 12 controls the power supply control circuit 42 so that power supply is supplied to the CPU 12, the operation button detecting circuit 24, the operation buttons 26a, and the like. In the power saving mode, control is exerted so that power consumption of the image forming apparatus 10 is equal to or less than a predetermined value (for example, several percent of the maximum amount of power consumption). Therefore, the types and the number of components to which power supply is supplied in the power saving mode are determined in consideration of the predetermined value and the amounts of power consumption of the components. For example, in the power saving mode, backlight of the display 22 is turned off, and the various software keys are not displayed. When the image forming apparatus 10 is connected to a network, power supply is also supplied to a connection circuit for connection to the network in the power saving mode.

In the image forming apparatus 10 according to the first embodiment, a first given time (for example, 20 to 30 seconds) for switching from the normal mode to the power saving mode is predetermined. Therefore, in response to a state in which a time for which no user operations have performed exceeds the first given time in the normal mode, the image forming apparatus 10 is automatically switched from the normal mode to the power saving mode. User operations mean operations on the units of the image forming apparatus 10. For example, user operations include an operation in which a user touches the touch panel 20, an operation in which a user selects an operation button 26a, an operation in which a user puts a document on the platen glass or the ADF, an operation in which a user opens the document cover 30a, and an operation in which a user takes sheets of paper from the paper output tray 40.

When a billing apparatus is connected to the image forming apparatus 10, user operations include an operation in which a user drops money into the billing apparatus and an operation in which a user inserts a prepaid card into the billing apparatus.

Further, when the image forming apparatus 10 includes a connection unit into which a recording medium may be loaded, user operations include an operation in which a user loads a recording medium into the connection unit.

In the power saving mode, when a user operation is performed, switching from the power saving mode to the normal mode is automatically performed in response to the operation on the image forming apparatus 10.

User operations that cause switching from the power saving mode to the normal mode to be performed do not include an operation in which a user touches the touch panel 20. This is because, as described above, in the power saving mode, the backlight of the display 22 is turned off and various software keys are not displayed.

Further, in the image forming apparatus 10 according to the first embodiment, a software key (hereinafter referred to as a “power saving inhibition icon”) 102 for inhibiting switching from the normal mode to the power saving mode is provided.

FIG. 3 is a diagram illustrating an exemplary home screen 100. As described above, the home screen 100 is a screen for selecting various jobs. On the home screen 100, the images of software keys (icons) for selecting the jobs, such as copying, printing, faxing, and scanning, and the images of software keys for displaying operation screens (setting screens) for the jobs are displayed. As described above, the power saving inhibition icon 102 is provided on the home screen 100 displayed on the display 22.

Instead of the power saving inhibition icon 102, or in addition to the power saving inhibition icon 102, a hardware key (power saving inhibition button) for inhibiting switching from the normal mode to the power saving mode may be provided. In this case, for example, the operation buttons 26a provided on the operation panel 26 include the power saving inhibition button.

When the power saving inhibition icon is touched in the normal mode, switching to the power saving mode is inhibited. When switching to the power saving mode is inhibited, even if a time for which no user operations have been performed exceeds the first given time, switching to the power saving mode is not performed. That is, the normal mode is maintained. In response to inhibition of switching to the power saving mode, the first given time may be substantially extended (for example, 100 seconds).

In some image forming apparatuses 10 of the related art, in the case where switching to the power saving mode is inhibited, when a state in which sheets of paper are present on the paper output unit of the manual feeding unit 34 is changed to a state in which no sheets of paper are present, inhibition of switching to the power saving mode is canceled. However, when a user forgets taking sheets of paper from the paper output unit of the manual feeding unit 34, the state in which sheets of paper are present on the paper output unit of the manual feeding unit 34 is maintained. Therefore, in the image forming apparatuses 10 of the related art, inhibition of switching to the power saving mode may not be canceled.

In the case where the image reading unit 30 is used only to scan a document, when a document on the platen glass is scanned without use of the ADF, sheets of paper are sometimes not conveyed to the paper output unit of the manual feeding unit 34. In this case, sheets of paper will not be present on the paper output unit of the manual feeding unit 34. Therefore, inhibition of switching to the power saving mode is not canceled.

Thus, in an image forming apparatus of the related art, inhibition of switching to the power saving mode is sometimes not canceled. When inhibition of switching to the power saving mode is not canceled, a problem of wasted power consumption arises.

Further, sheets of paper may be taken from the paper output unit of the manual feeding unit 34 during execution of (midway through) a job in order that a user checks the document. In this case, inhibition of switching to the power saving mode is canceled during execution of the job. Therefore, switching from the normal mode to the power saving mode may be performed at an inappropriate timing.

Thus, when switching from the normal mode to the power saving mode is performed at an inappropriate timing, there arises a problem in that settings for a job are reset and a user has to do additional operations such as making settings of the job from the first step again.

Therefore, in the first embodiment, to avoid the above-described problem, switching between the normal mode and the power saving mode is appropriately performed, achieving efficient power saving.

Specifically, in the image forming apparatus 10 according to the first embodiment, when a job that has been first performed after switching to the power saving mode is inhibited is completed, the inhibition of switching to the power saving mode is canceled.

Whether or not a job is completed is determined in accordance with the location or the usage of the image forming apparatus 10. For example, the image forming apparatus 10 that is installed in a store, such as a supermarket or a convenience store, may be provided with a billing apparatus (for example, a coin vender) that is communicatively coupled to the image forming apparatus 10 in a wired or wireless manner. In this case, when change, a prepaid card, or the like is returned, completion of a job may be determined.

If a job having been set is copying, when the last sheet of paper on which an image has been formed in the job is ejected to the paper output tray 40, completion of the job may be determined.

Further, the image forming apparatus 10 may be provided with a connection unit (such as a memory slot) into which various recording media (such as a secure digital (SD) card and a Universal Serial Bus (USB) memory) may be loaded. In this case, when a recording medium that has been loaded is removed from the connection unit, completion of a job may be determined.

Furthermore, a user may be made to instruct completion of a job. In this case, for example, a screen for prompting a user to select whether or not a job is to be completed is displayed on the display 22 with the touch panel 20. A software key (job completion key) for instructing completion of a job may be displayed. In this case, after the job completion key is selected, when an instruction to complete a job is received, completion of the job is determined. Alternatively, a software key or hardware key for resetting settings of a job may be provided. In this case, after the key for resetting is selected, when a reset instruction is received, completion of a job is determined.

When use of the image forming apparatus 10 is started, user authentication of a user who is to use the image forming apparatus 10 may be performed. In this case, in the case where a user who has logged in when switching to the power saving mode is inhibited is logged out, completion of a job may be determined.

The above-described operations performed by the image forming apparatus 10 are implemented by the CPU 12 executing control programs stored in the RAM 14. Specific processes will be described below by using a flowchart.

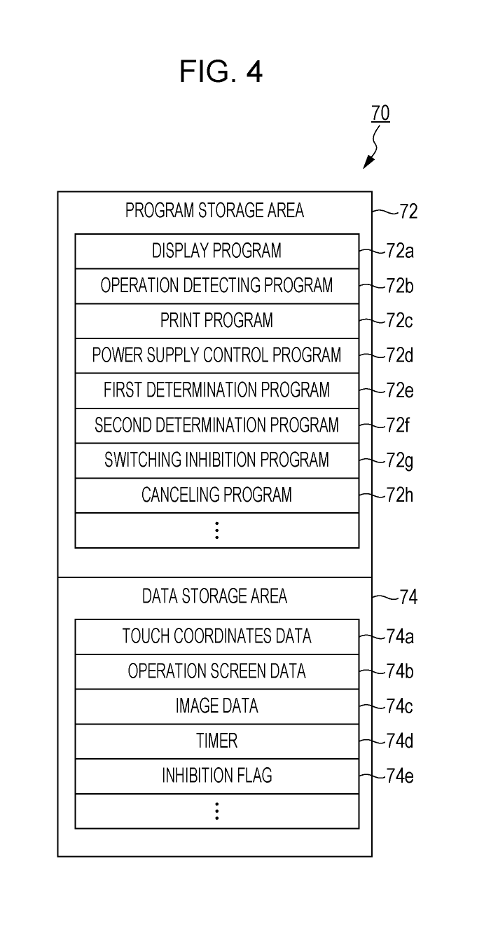

FIG. 4 is a diagram illustrating an exemplary memory map 70 on the RAM 14 illustrated in FIG. 2. As illustrated in FIG. 4, the RAM 14 includes a program storage area 72 and a data storage area 74. In the program storage area 72 on the RAM 14, as described above, the control programs of the image forming apparatus 10 are stored. The control programs include a display program 72a, an operation detecting program 72b, a print program 72c, a power supply control program 72d, a first determination program 72e, a second determination program 72f, a switching inhibition program 72g, and a canceling program 72h.

The display program 72a is a program for controlling the display control circuit 18 so that various screens, such as the home screen 100 and setting screens, are displayed on the display 22.

The operation detecting program 72b is a program for detecting operations performed on the units of the image forming apparatus 10. For example, the operation detecting program 72b is a program for obtaining touch coordinates data that is output from the touch panel 20 and detecting operations performed on various icons included on various screens such as the home screen 100 displayed on the display 22. The operation detecting program 72b is also a program for detecting operation input from the operation buttons 26a.

The print program 72c is a program for forming a color or monochrome image on a recording medium (sheet of paper) in accordance with image data 74c or the like described below.

The power supply control program 72d is a program for controlling supplying and stopping of power supply to the components of the image forming apparatus 10. The CPU 12 controls the power supply control circuit 42 according to the power supply control program 72d. As described above, in the normal mode, the CPU 12 controls the power supply control circuit 42 so that power supply is supplied to all of the components of the image forming apparatus 10 according to the power supply control program 72d. In contrast, in the power saving mode, the CPU 12 controls the power supply control circuit 42 so that power supply to some of the components of the image forming apparatus 10 is stopped according to the power supply control program 72d.

The first determination program 72e is also a program for determining whether or not a time for which the image forming apparatus 10 has not been operated exceeds the first given time.

The second determination program 72f is also a program for determining whether or not a job performed by the image forming apparatus 10 has been completed.

The switching inhibition program 72g is a program for inhibiting switching from the normal mode to the power saving mode when a touch on the power saving inhibition icon 102 is detected according to the operation detecting program 72b.

The canceling program 72h is a program for canceling inhibition of switching from the normal mode to the power saving mode, when it is determined that a job that has been first performed after switching from the normal mode to the power saving mode is inhibited according to the switching inhibition program 72g has been completed according to the second determination program 72f.

In the program storage area 72, programs and the like (not illustrated) for selecting and performing various functions are stored.

In the data storage area 74 on the RAM 14, touch coordinates data 74a, operation screen data 74b, the image data 74c, a timer 74d, an inhibition flag 74e, and the like are stored.

The touch coordinates data 74a is touch coordinates data detected (obtained) according to the operation detecting program 72b. The detected touch coordinates data 74a is chronologically stored.

The operation screen data 74b is image data about various operation screens such as the home screen 100 displayed on the display 22.

The image data 74c is, as described above, image data that is obtained by the image reading unit 30 reading a document, image data that is received from the outside, or the like.

The timer 74d is a timer for counting a time for which no user operations have been performed in the normal mode, and is provided inside the image forming apparatus 10 (the CPU 12 or the RAM 14), which is not illustrated.

The inhibition flag 74e is a flag indicating whether or not switching from the normal mode to the power saving mode has been inhibited. For example, the inhibition flag 74e is constituted by a one-bit register. When the inhibition flag 74e is on, switching from the normal mode to the power saving mode is inhibited. When the inhibition flag 74e is off, switching from the normal mode to the power saving mode is enabled.

In the data storage area 74, other data that is used in execution of the control programs, such as operation data from the operation buttons 26a on the operation panel 26, is stored, or a register used in execution of the control programs is provided (not illustrated).

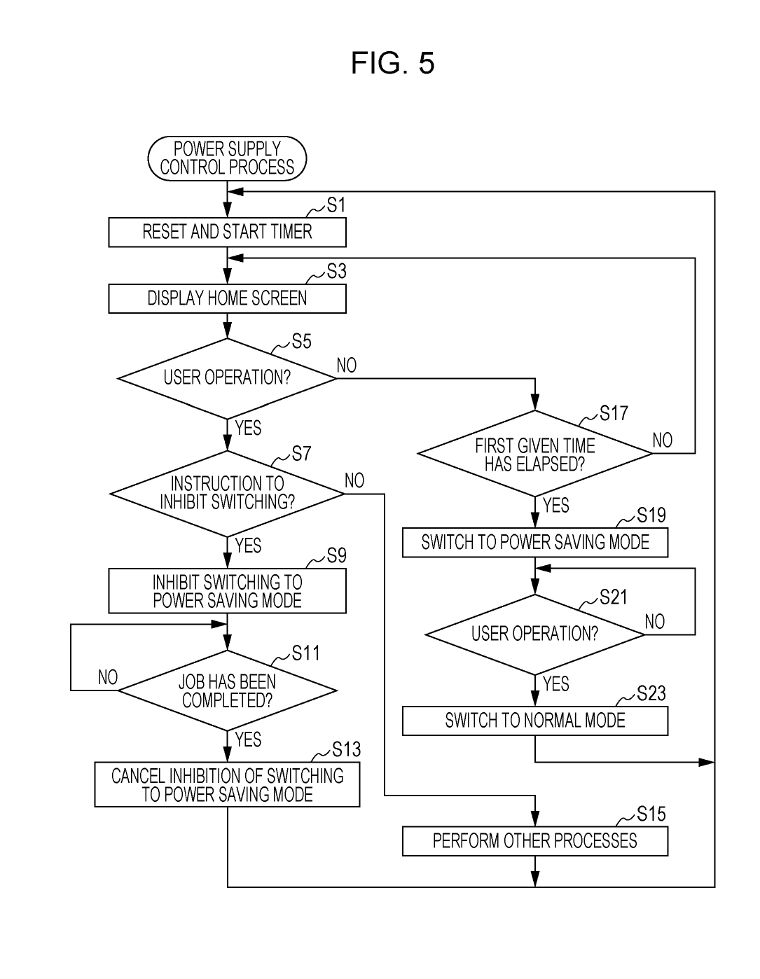

FIG. 5 is a flowchart of an exemplary power supply control process performed in the image forming apparatus 10 illustrated in FIG. 1. The power supply control process is started when the image forming apparatus 10 is set to the normal mode. When the power supply control process is started, the inhibition flag 74e is off.

As illustrated in FIG. 5, when the CPU 12 starts the power supply control process, the CPU 12 resets and starts the timer 74d in step S1, and displays the home screen 100 on the display 22 in step S3.

In the subsequent step S5, it is determined whether or not a user operation has been performed. If the result is “YES” in step S5, that is, if it is determined that a user operation has been performed, it is determined whether or not the user operation is an instruction to inhibit switching to the power saving mode in step S7.

If the result is “YES” in step S7, that is, if it is determined that the user operation is an instruction to inhibit switching to the power saving mode, switching to the power saving mode is inhibited in step S9, and the process proceeds to step S11. In step S9, the CPU 12 turns on the inhibition flag 74e. In step S11, it is determined whether or not a job has been completed. That is, the CPU 12 determines whether or not a job that has been first performed after switching to the power saving mode is inhibited has been completed.

If the result is “NO” in step S11, that is, if it is determined that the job has not been completed, the process returns back to the same step S11. In contrast, if the result is “YES” in step S11, that is, if it is determined that the job has been completed, the inhibition of switching to the power saving mode is canceled in step S13, and the process returns back to step S1. In step S13, the CPU 12 turns off the inhibition flag 74e.

If the result is “NO” in step S7, that is, if it is determined that the user operation is not an instruction to inhibit switching to the power saving mode, other processes are performed in step S15, and the process returns back to step S1. The other processes include selection of a job according to a user instruction, setting of various settings for a job, and starting and stopping of a job.

If the result is “NO” in step S5, that is, if it is determined that no user operations have been performed, it is determined whether or not the first given time has elapsed in step S17. Specifically, the CPU 12 determines whether or not the count value of the timer 74d exceeds the first given time.

If the result is “NO” in step S17, that is, if it is determined that the first given time has not elapsed, the process returns back to step S3. In contrast, if the result is “YES” in step S17, that is, if it is determined that the first given time has elapsed, switching to the power saving mode is performed in step S19.

In the subsequent step S21, it is determined whether or not a user operation has been performed. If the result is “NO” in step S21, that is, if it is determined that no user operations have been performed, the process returns back to the same step S21. In this case, the power saving mode is maintained. If the result is “YES” in step S21, that is, if it is determined that a user operation has been performed, switching to the normal mode is performed in step S23, and the process returns back to step S1.

In the first embodiment, when inhibition of switching to the power saving mode is canceled, the process returns back to step S1. Therefore, the timer 74d is reset. Thus, when a time for which no user operations have been performed from the time point at which inhibition of switching to the power saving mode is canceled exceeds the first given time, switching from the normal mode to the power saving mode is performed.

In the first embodiment, when a job that has been first performed after switching to the power saving mode is inhibited is completed, the inhibition of switching to the power saving mode is canceled. Therefore, inhibition of switching to the power saving mode is canceled with certainty. Therefore, wasted power consumption may be hindered, and efficient power saving may be achieved.

According to the first embodiment, switching to the power saving mode is not performed at least until the first job is completed. Therefore, until the first job is completed, settings and the like of the job are not reset, improving usability.

### Second Embodiment

The image forming apparatus 10 according to a second embodiment is the same as the image forming apparatus 10 according to the first embodiment except that, after switching to the power saving mode is inhibited, when a given time has elapsed, the inhibition of switching to the power saving mode is canceled. Accordingly, different points will be described in detail, and repeated description will be avoided or will be briefly made.

In the image forming apparatus 10 according to the second embodiment, when switching to the power saving mode is inhibited, the CPU 12 refers to the count value of the timer 74d and determines whether or not a given time (hereinafter referred to as a “second given time”) longer than the first given time has elapsed. When the second given time has elapsed from a time point at which the switching to the power saving mode is inhibited, the CPU 12 cancels the inhibition of switching to the power saving mode.

The second given time is set to a sufficient time in which a user finishes using the image forming apparatus 10. A sufficient time in which a user operates the image forming apparatus 10 is a time in which, even when a user who is unfamiliar with operations on the image forming apparatus 10 operates the image forming apparatus 10 while being at a loss, inhibition of switching to the power saving mode is not canceled during an operation on the image forming apparatus 10. For example, the second given time is set at five minutes or longer.

That is, in the second embodiment, in step S11 in the power supply control process in the first embodiment, instead of determining whether or not a job has been completed, the CPU 12 determines whether or not the second given time has elapsed. If the CPU 12 determines that the second given time has not elapsed, the process returns back to the same step S11. In contrast, if the CPU 12 determines that the second given time has elapsed, the CPU 12 cancels inhibition of switching to the power saving mode in step S13, and the process returns back to step S1.

According to the second embodiment, after switching to the power saving mode is inhibited, when the second given time has elapsed, the inhibition of switching to the power saving mode is canceled. Therefore, when a user finishes using the image forming apparatus 10, the inhibition of switching to the power saving mode is canceled with certainty. Therefore, wasted power consumption is hindered.

According to the second embodiment, the second given time is set at a sufficient time in which a user finishes using the image forming apparatus 10. Therefore, a state in which switching to the power saving mode is performed and in which settings of a job are reset will not occur during a user's operation on the image forming apparatus 10. Accordingly, usability is improved.

### Third Embodiment

The image forming apparatus 10 according to a third embodiment is the same as that according to the first embodiment except that, when the normal mode is set, a user is made to select whether or not an instruction to inhibit switching to the power saving mode is to be given. Accordingly, different points will be described, and repeated description will be avoided or will be briefly made.

In the image forming apparatus 10 according to the third embodiment, a selection screen 104 for giving an instruction to inhibit switching to the power saving mode is displayed on the display 22 when the normal mode is set. The expression “when the normal mode is set” means when the main power supply of the image forming apparatus 10 is turned on and when switching from the power saving mode to the normal mode is performed.

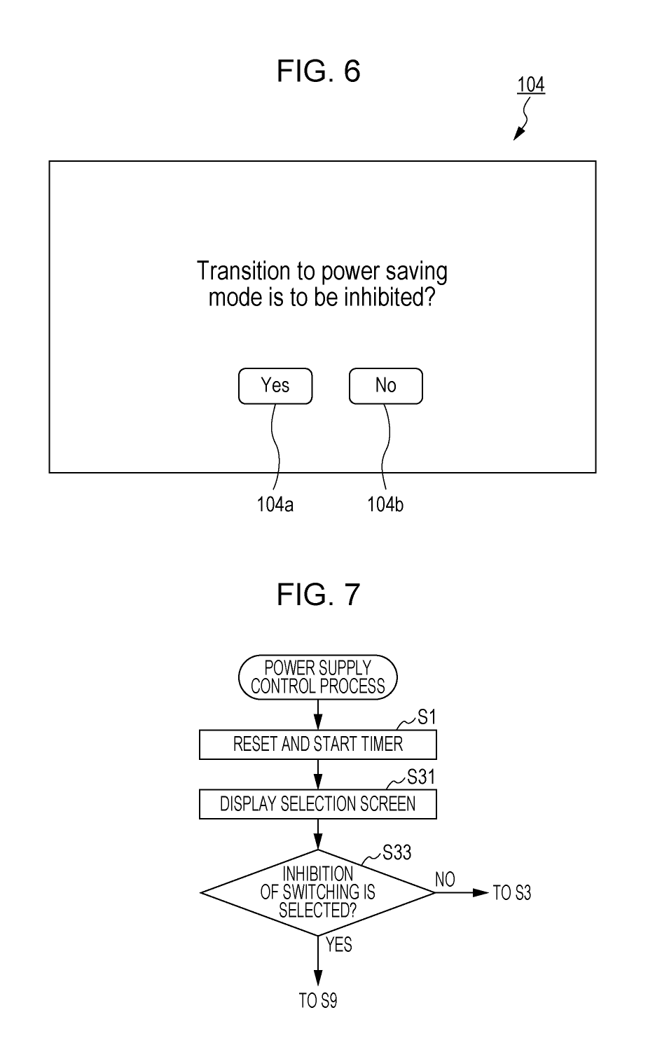

FIG. 6 is a diagram illustrating an exemplary selection screen 104 according to the third embodiment. As illustrated in FIG. 6, a message for prompting determination about whether or not switching to the power saving mode is to be inhibited is displayed on the selection screen 104. On the selection screen 104, a “Yes” button 104a for giving an instruction to inhibit switching to the power saving mode and a “No” button 104b for not giving an instruction to inhibit switching to the power saving mode are displayed.

When the “Yes” button 104a is selected on the selection screen 104, that is, when a user intends to give an instruction to inhibit switching to the power saving mode, switching to the power saving mode is inhibited, and the home screen 100 illustrated in FIG. 3 is displayed. As described above, when switching to the power saving mode is inhibited, switching to the power saving mode is not performed in a period from displaying of the home screen 100 till completion of the first job.

When the “No” button 104b is selected on the selection screen 104, that is, when a user does not intend to give an instruction to inhibit switching to the power saving mode, switching to the power saving mode is not inhibited, and the home screen 100 is displayed. In this case, as described above, when a time for which no user operations have been performed exceeds the first given time, switching from the normal mode to the power saving mode is automatically performed.

FIG. 7 is a flowchart of an exemplary power supply control process according to the third embodiment. Similarly to the first embodiment, the power supply control process is performed when the image forming apparatus 10 is in the normal mode. Processes the same as those described in the power supply control process (FIG. 5) according to the first embodiment will not be described or will be briefly described.

As illustrated in FIG. 7, when the CPU 12 starts the power supply control process, the CPU 12 resets and starts the timer 74d in step S1, and displays the selection screen 104 on the display 22 in step S31.

In the subsequent step S33, the CPU 12 determines whether or not inhibition of switching to the power saving mode has been selected. In this step, the CPU 12 obtains the touch coordinates data 74a detected according to the operation detecting program 72b, and determines whether or not the “Yes” button 104a on the selection screen 104 has been touched.

If the result is “YES” in step S33, that is, if the “Yes” button 104a on the selection screen 104 has been touched, the process proceeds to step S9 (see FIG. 5), and switching to the power saving mode is inhibited.

If the result is “NO” in step S33, that is, if the “Yes” button 104a on the selection screen 104 has not been touched (the “No” button 104b on the selection screen 104 has been touched), the process proceeds to step S3 (see FIG. 5). Switching to the power saving mode is not inhibited, and the home screen 100 is displayed on the display 22.

The process in step S3 and its subsequent processes are the same as those in the first embodiment, and will not be described.

According to the third embodiment, when the normal mode is started, a user is made to select whether or not an instruction to inhibit switching to the power saving mode is to be given. Therefore, a user who uses the image forming apparatus 10 for the first time may easily give an instruction to inhibit switching to the power saving mode.

The aspect described in the third embodiment may be employed in combination with the second embodiment. In this case, when inhibition of switching to the power saving mode is selected, a screen for setting the second given time may be displayed on the display 22, and a user may be made to set the second given time that is a time until inhibition of switching to the power saving mode is canceled. Candidates of the second given time, such as two minutes, three minutes, and five minutes, may be set in advance, and a user may be made to select the second given time from among the candidates.

Specific values, screen configurations, and the like described in the above-described embodiments are exemplary, and may be changed as appropriate in accordance with an actual product.

The execution order of steps in the flowcharts illustrated in the above-described embodiments may be changed as appropriate as long as the same result is obtained.

The present disclosure contains subject matter related to that disclosed in Japanese Priority Patent Application JP 2016-141643 filed in the Japan Patent Office on Jul. 19, 2016, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image forming apparatus having a power saving state and a normal state, the power saving state being a state in which power consumption is restricted to a given value or less, the normal state being a state in which power consumption is not restricted, the image forming apparatus comprising:
a switching unit that switches the image forming apparatus between the normal state and the power saving state when a given condition is satisfied;
a determination unit that determines whether or not an instruction to inhibit the switching performed by the switching unit is given, when the image forming apparatus is in the normal state;
an inhibition unit that temporarily inhibits the switching performed by the switching unit, when the determination unit determines that the instruction to inhibit the switching is given; and
a canceling unit that cancels the inhibition of the switching when a job performed in the image forming apparatus is completed, the inhibition being performed by the inhibition unit.

2. The image forming apparatus according to claim 1, further comprising:
an input unit that includes a display unit and a touch panel, the display unit having a display surface, the touch panel being provided on the display surface of the display unit, and that displays an instruction key on the display surface of the display unit, the instruction key being used to give the instruction to inhibit the switching,
wherein, in response to output from the touch panel, if the instruction key is operated, the determination unit determines that the instruction to inhibit the switching is given.

3. The image forming apparatus according to claim 2,
wherein the input unit displays a selection screen on the display surface of the display unit, the selection screen being used to make a user select whether or not the instruction to inhibit the switching is to be given, and
wherein the selection screen includes the instruction key and is displayed on a foreground of the display surface of the display unit.

4. The image forming apparatus according to claim 3,
wherein, when the switching unit performs switching from the power saving state to the normal state, the input unit displays the selection screen on the display surface of the display unit.

5. An image forming apparatus having a power saving state and a normal state, the power saving state being a state in which power consumption is restricted to a given value or less, the normal state being a state in which power consumption is not restricted, the image forming apparatus comprising:
a switching unit that switches the image forming apparatus between the normal state and the power saving state when a given condition is satisfied;
a determination unit that determines whether or not an instruction to inhibit the switching performed by the switching unit is given, when the image forming apparatus is in the normal state;
an inhibition unit that, when the determination unit determines that the instruction to inhibit the switching is given, inhibits the switching until a given time is elapsed, the switching being performed by the switching unit; and
a canceling unit that cancels the inhibition of the switching when the given time is elapsed, the inhibition being performed by the inhibition unit.

6. The image forming apparatus according to claim 5, further comprising:
an input unit that includes a display unit and a touch panel, the display unit having a display surface, the touch panel being provided on the display surface of the display unit, and that displays an instruction key on the display surface of the display unit, the instruction key being used to give the instruction to inhibit the switching,
wherein, in response to output from the touch panel, if the instruction key is operated, the determination unit determines that the instruction to inhibit the switching is given.

7. The image forming apparatus according to claim 6,
wherein the input unit displays a selection screen on the display surface of the display unit, the selection screen being used to make a user select whether or not the instruction to inhibit the switching is to be given, and
wherein the selection screen includes the instruction key and is displayed on a foreground of the display surface of the display unit.

8. The image forming apparatus according to claim 7,
wherein, when the switching unit performs switching from the power saving state to the normal state, the input unit displays the selection screen on the display surface of the display unit.

9. A non-transitory computer readable medium including a control program for an image forming apparatus having a power saving state and a normal state, the power saving state being a state in which power consumption is restricted to a given value or less, the normal state being a state in which power consumption is not restricted, the control program causing a computer in the image forming apparatus to execute a process comprising:
switching the image forming apparatus between the normal state and the power saving state when a given condition is satisfied;
determining whether or not an instruction to inhibit the switching is given, when the image forming apparatus is in the normal state;
inhibiting the switching temporarily when the determining determines that the instruction to inhibit the switching is given; and
canceling the inhibition of the switching when a job performed in the image forming apparatus is completed.

10. A non-transitory computer readable medium including a control program for an image forming apparatus having a power saving state and a normal state, the power saving state being a state in which power consumption is restricted to a given value or less, the normal state being a state in which power consumption is not restricted, the control program causing a computer in the image forming apparatus to execute a process comprising:
switching the image forming apparatus between the normal state and the power saving state when a given condition is satisfied;
determining whether or not an instruction to inhibit the switching is given, when the image forming apparatus is in the normal state;
inhibiting the switching until a given time is elapsed, the inhibiting being performed when the determining determines that the instruction to inhibit the switching is given; and
canceling the inhibition of the switching when the given time is elapsed.

11. A control method for an image forming apparatus having a power saving state and a normal state, the power saving state being a state in which power consumption is restricted to a given value or less, the normal state being a state in which power consumption is not restricted, the control method comprising:
switching the image forming apparatus between the normal state and the power saving state when a given condition is satisfied;
determining whether or not an instruction to inhibit the switching is given, when the image forming apparatus is in the normal state;
inhibiting the switching temporarily when the determining determines that the instruction to inhibit the switching is given; and
canceling the inhibition of the switching when a job performed in the image forming apparatus is completed.

12. A control method for an image forming apparatus having a power saving state and a normal state, the power saving state being a state in which power consumption is restricted to a given value or less, the normal state being a state in which power consumption is not restricted, the control method comprising:
switching the image forming apparatus between the normal state and the power saving state when a given condition is satisfied;
determining whether or not an instruction to inhibit the switching is given, when the image forming apparatus is in the normal state;
inhibiting the switching until a given time is elapsed, the inhibiting being performed when the determining determines that the instruction to inhibit the switching is given; and
canceling the inhibition of the switching when the given time is elapsed.
